(19) United States
(12) Patent Application Publication
(10) Pub. No.: US 2007/0010149 A1
(43) Pub. Date: Jan. 11, 2007

(54) Antivirus-resistant and waterproof fabric

(75) Inventor: Chung-Hu Hsiao, Taichung City (TW)

Correspondence Address: BROWDY AND NEIMARK, P.L.L.C.;624 NINTH STREET, NW, SUITE 300, WASHINGTON, DC, 20001-5303, US

(73) Assignee: Tiong Liong Industrial Co., Ltd., Da-Ya Shian (TW)

(21) Appl. No.: 11/172,912

(22) Filed: Jul. 5, 2005

(51) Int. Cl. B32B 27/12

(52) U.S. Cl. 442/86; 442/286; 442/394; 442/398

(57) ABSTRACT

Disclosed is an antivirus-resistant and waterproof fabric, which includes a base fabric layer, an isolation layer formed of PU, PE, or TPU and covered on one side of the base fabric layer to protect against osmosis of blood and virus, and a protective layer formed of expanded polytetrafluroethlene and covered on one side of the isolation layer opposite to the base fabric layer to protect the fabric against chemicals infringement.

### BACKGROUND OF THE INVENTION

1. Field of the Invention

The present invention relates to a fabric and more particularly, to an antivirus-resistant and waterproof fabric.

2. Description of the Related Art

Conventionally, a textile fabric may be covered with a layer of EPTEF (expanded polytetrafluoethlene) to have waterproof and breathing characteristics. By means of the material characteristics of EPTEF of being not adhesive, being acid and alkali resistant and waterproof, and having several hundred millions of pores per square inches, a textile fabric that is covered with a layer of EPTEF can breathe and block water. However, a fabric made in this manner is not protective against certain substances having smaller molecules such as flood or virus.

Taiwan Patent Publication No. 150382 (equivalent to U.S. Pat. No. 4,772,510), entitled “Fabric for protective garments”, discloses a composite fabric that is particularly useful in protective garments has an outer layer of polyvinyl fluoride or polyvinylidene fluoride or copolymers thereof bonded to a film of polyvinyl alcohol polymer or copolymers thereof which in turn is bonded to a textile fabric substrate. However, because the film of polyvinyl alcohol polymer or copolymers thereof can be hydrolyzed, this structure of fabric is not washer with water, i.e., the fabric is not repeatedly usable and must be thrown away when used.

### SUMMARY OF THE INVENTION

The present invention has been accomplished under the circumstances in view. It is the main object of the present invention to provide an antivirus-resistant and waterproof fabric, which is reusable and washable and which can breathe and block water and virus.

To achieve this and other objects of the present invention, the antivirus-resistant and waterproof fabric comprises a base fabric layer, an isolation layer covered on one side of the base fabric layer to protect against osmosis of blood and virus, and a protective layer formed of expanded polytetrafluroethlene and covered on one side of the isolation layer opposite to the base fabric layer.

### BRIEF DESCRIPTION OF THE DRAWINGS

FIG. 1 is an exploded view of an antivirus waterproof fabric according to the present invention.

FIG. 2 is an exploded view of an alternate form of the antivirus waterproof fabric according to the present invention.

### DETAILED DESCRIPTION OF THE INVENTION

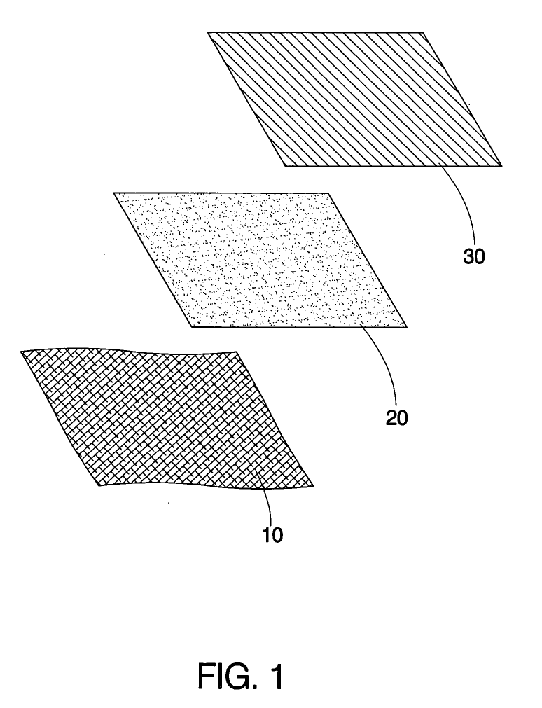

Referring to FIG. 1, an antivirus-resistant and waterproof fabric in accordance with the first embodiment of the present invention is shown comprised of a fabric substrate 10, an isolation layer 20, and a protective layer 30. The fabric substrate 10 is a base layer that can be formed of any of a variety of textile fabrics. The isolation layer 20 is a thin film of PU (polyurethane), PE (polyethylene), or TPU (polyurethane thermoplastic elastomer) covered on one side of the fabric substrate 10. The protective layer 30 is a thin film of EPTEF (expanded polytetrafluroethlene) covered on one side of the isolation layer 20 opposite to the fabric substrate 10 to protect the fabric against chemicals infringement.

According to this embodiment, the fabric substrate 10 is a knitted fabric. The isolation layer 20 can be covered on the fabric substrate 10 by coating, bonding, or dipping. The isolation effect of the isolation layer 20 is directly proportional to its thickness. However, increasing the thickness of the isolation layer 20 relatively reduces the softness of the product. Therefore, the thickness of the isolation layer 20 must be made subject to actual requirement. The thickness of the isolation layer 20 is preferably within 3 μm to 120 μm, or most preferably within 5 μm to 100 μm. At final, the protective layer 30 is covered on the isolation layer 20 opposite to the fabric substrate 10.

An antivirus waterproof fabric made according to the aforesaid first embodiment of the present invention eliminates the drawbacks of the prior art designs, and is reusable and washer. This structure of fabric isolates substances of small molecules and protects against osmosis of blood and virus while maintaining the material characteristics of EPTEF of being not adhesive, being acid and alkali resistant and waterproof, and having several hundred millions of pores per square inches.

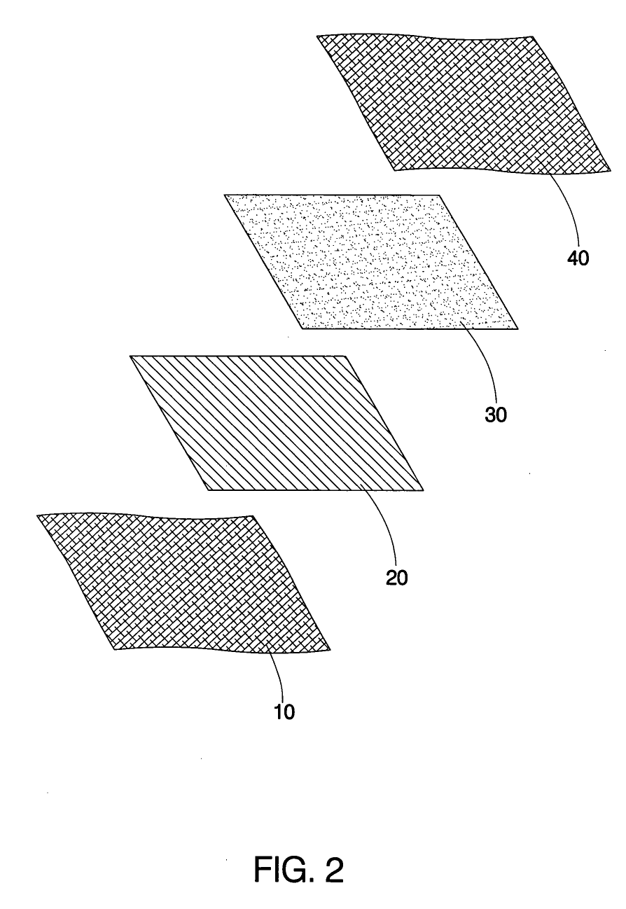

FIG. 2 is an exploded view of an antivirus-resistant and waterproof fabric according to the second embodiment of the present invention. According to this embodiment, the antivirus waterproof fabric is comprised of a first fabric layer 10, an isolation layer 20, a protective layer 30, and a second fabric layer 40. The first fabric layer 10 is a knitted fabric. The isolation layer 20 is a thin film of PU, PE, or TPU covered on one side of the first fabric layer 10. The protective layer 30 is a thin film of EPTEF (expanded polytetrafluroethlene) covered on one side of the isolation layer 20 opposite to the first fabric layer 10. The second fabric layer 40 is covered on one side of the protective layer 30 opposite to the isolation layer 20. The second fabric layer 40 can be any of a variety of cloths or fabrics. The first fabric layer 10 and the second fabric layer 40 can be of same or different materials. According to this embodiment, the second fabric layer 40 is a plain cloth.

Although particular embodiments of the invention have been described in detail for purposes of illustration, various modifications and enhancements may be made without departing from the spirit and scope of the invention. Accordingly, the invention is not to be limited except as by the appended claims

What is claimed is:

1. An antivirus-resistant and waterproof fabric comprising a base fabric layer, an isolation layer covered on one side of said base fabric layer to protect against osmosis of blood and virus, and a protective layer formed of expanded polytetrafluroethlene and covered on one side of said isolation layer opposite to said base fabric layer.

2. The antivirus-resistant and waterproof fabric as claimed in claim 1, wherein said isolation layer is a thin film of polyurethane.

3. The antivirus-resistant and waterproof fabric as claimed in claim 1, wherein said isolation layer is a thin film of polyethylene.

4. The antivirus-resistant and waterproof fabric as claimed in claim 1, wherein said isolation layer is a thin film of polyurethane thermoplastic elastomer.

5. The antivirus-resistant and waterproof fabric as claimed in claim 1, further comprising a second fabric layer covered on one side of said protective layer opposite to said isolation layer.

6. The antivirus-resistant and waterproof fabric as claimed in claim 1, wherein said protective layer has a thickness within 3 μm˜120 μm.
